(19) United States
(12) Patent Application Publication
(10) Pub. No.: US 2007/0280227 A1
(43) Pub. Date: Dec. 6, 2007

(54) Packet distribution system using reproducing appartus and packet distribution method

(75) Inventors: Kazuya Suzuki, Tokyo (JP); Masahiro Jibiki, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/802,952

(22) Filed: May 29, 2007

(30) Foreign Application Priority Data
May 30, 2006 (JP) 2006-149960

(51) Int. Cl. H04L 12/56

(52) U.S. Cl. 370/389

(57) ABSTRACT

A packet distribution system includes distribution server configured to transmit packets of a video image; a user terminal, a packet transfer apparatus configured to transfer the packets received through a network from the distribution server to the user terminal such that the video image is reproduced on the user terminal, and to generate timing data from the received packets. A reproducing apparatus is configured to receive the timing data from the packet transfer apparatus, to receive the packets from the distribution server, and to transmit the received packets to the center terminal based on the timing data such that the video image is reproduced on the center terminal.

### CROSS REFERENCE

This application is based upon and claims the benefit of priority from Japanese patent application No. 20006-149960, filed on May 30, 2006. Also, this application relates to the U.S. patent application Ser. No. ______, titled “SYSTEM AND METHOD FOR MEASURING DISTRIBUTION QUALITY OF VIDEO IMAGE” by Kazuya SUZUKI and Masahiro JIBIKI, claiming the priority based on Japanese Patent Application No. 2006-149959 filed on May 30, 2006. The disclosures of these applications are incorporated herein by reference.

### TECHNICAL FIELD

The present invention relates to a packet distribution system in which apparatus a reproduction state of a video image in a user home is monitored on a center side.

### BACKGROUND ART

In association with the popularization of a broadband network, the possibility of attaining a video image distribution service of a high image quality becomes practical, although its attainment is difficult in a narrow band network. Also, since a multicast technique is used for distribute video image packets to many users while the bands for a server and a network are saved.

However, the video image distribution using the network has the following problems. In the video image reproduction using the network, when due to the problem of the network, the phenomenon has occurred that some of packets of the image data are lost or do not arrive within a predetermined time, severe influence appears on the video image to be reproduced. In particular, in the protocol IP of a network layer, there is a possibility that packets are lost at a time of congestion on the specification. In a typical communication, the low reliability of the protocol IP is compensated by using a function of arrival check or retransmission that is a protocol function in a transport layer as an upper layer of the network layer. Even in the video image distribution, a retransmission mechanism can be used for the packet loss. However, because it is necessary to buffer the packets for every distribution destination, until the arrival of the packets can be confirmed, so that the load becomes weight. Thus, it is difficult to employ this mechanism for the distribution to many users.

In the video image distribution using the multicast, the video image is distributed to a many users. That is, since the multicast is a one-to-multiple communication, the quality control for each user is difficult. If a quality control function is employed in a form of being added on the existing multicast stream, the quality statistics data in a packet level can be attained in the network in units of users using this function.

However, actually, when a problem has occurred in the video image reproduction, its analysis cannot be performed even by using the statistics data in many cases. If the behavior of the network causing an abnormal state can be assumed in advance, it is sufficient that the statistics data is monitored to detect the behavior. However, it is actually difficult to predict what kind of behavior is revealed by the network in advance. After the influence appears in the video image reproduction, it is necessary to check the behavior of its cause. For example, there would be a case that a problem occurs in the video image reproduction, since a large change in transmission delay of the packet or the value of jitter is caused, or the periodical change is generated and the change is larger than a predicted level.

It is not sufficient to monitor the statistics data of the distribution quality. How the behavior of the network that is not assumed in advance influences the video image reproduction is not known. For this reason, when the foregoing problem has occurred, what kind of the problem has occurred in the video image reproduction and distribution quality data in units of packets are compared with each other.

The first problem is in that when a problem has occurred in video image reproduction, a reason cannot be searched from only statistics data of the distribution quality in many cases. Previously, there is a method of checking the statistics data of the quality data with regard to the distribution state of the video image. However, for the pre-assumed behavior, it is necessary to monitor the statistics data to check the behavior. However, it is actually difficult to predict a type of the behavior revealed by the network in advance. In such a case, after the occurrence of the influence on the video image reproduction, it is necessary to check the behavior resulting from its cause. In this case, the detailed quality data in units of packets are required.

The second problem is in that a maintenance person is required to go to an actual field where a problem having actually occurred in the video image reproduction and to carry out the check in order to check the reproduction state of the video image. It was possible to refer to the quality data of the video image distribution state from a remote location. However, in order to search the cause when the problem has actually occurred in the video image reproduction, it is necessary to not only refer to the quality data, but also to check the type of the problem having actually occurred in the video image to be reproduced at the same time.

In order to perform those examinations, the maintenance person for checking the reproduction state of the video image is required to be sent to the actual field, and this required a cost and a time.

In conjunction with the above description, a technique to monitor distribution of a stream is described in Japanese Laid open Patent Application (JP-P2004-172748A). In this method, it is possible to monitor whether or not the stream is distributed. When the packets of the stream do not arrive due to any reason, its problem can be detected.

However, in a transmitting apparatus described in Japanese Laid Open Patent Application (JP-P2004-266350A), the transmission delay of the packet and the jitter are not considered. For this reason, although the packet actually arrives, the problem in the video image reproduction caused by the influence of the transmission delay, the variation in the jitter cannot be searched. More specifically, in the transmitting apparatus, an arrival time data acquiring unit acquires a data of an arrival time from the transmission of a data to reception of the data by a communication party for every directivity. A guard interval inserting unit inserts a guard interval of a length determined in accordance with the data of the arrival time into the transmission data. A transmission delaying unit sets a transmission delay time to a transmission data for every directivity in accordance with the data of the arrival time. A transmitting unit transmits the same transmission data through the plurality of directivities.

In the above description, Japanese Laid Open Patent Application (JP-P2004-357015A) discloses a communicating apparatus. This communicating apparatus contains a timing determining unit for detecting a timing differences between a reception timing of each of reception signals of a plurality of communication parties, which are multiplexed in time division, and a preset reference reception timing, number of plural times. A transmitting unit transmits the data of the timing difference each time the timing judging unit detects the timing difference.

### SUMMARY

The present invention provides a packet distribution system with a reproducing apparatus, in which a reproduction state of a video image is reproduced.

In an exemplary aspect of the present invention, a packet distribution system includes distribution server configured to transmit packets of a video image; a user terminal; a packet transfer apparatus configured to transfer the packets received through a network from the distribution server to the user terminal such that the video image is reproduced on the user terminal, and to generate timing data from the received packets; a center terminal; and a reproducing apparatus configured to receive the timing data from the packet transfer apparatus, to receive the packets from the distribution server, and to transmit the received packets to the center terminal based on the timing data such that the video image is reproduced on the center terminal.

Also, in another exemplary aspect of the present invention, a method of distributing packets for a video image, includes transmitting packets for a video image from a distribution server; receiving the packets through a network from the distribution server by a packet transfer apparatus to transfer to a user terminal such that the video image is reproduced on the user terminal; generating timing data from the packets received through the network by the packet transfer apparatus; receiving the packets from the distribution server by a reproducing apparatus; and transmitting the received packets to a center terminal based on the timing data by the reproducing apparatus such that the video image is reproduced on the center terminal.

Also, another exemplary aspect of the present invention, a reproducing apparatus includes a packet receiving section configured to receive packets from a distribution server; a packet transmitting section configured to transmit the packets to a center terminal; a real time clock configured to supply a current time; a packet buffer section configured to store the packets received by the packet receiving section; a timing data receiving section configured to receive a timing data of a set of an identifier for each of the packets and a reception time of the packet from a packet transfer apparatus; and a transmission scheduler configured to determine a transmission time of each of the packets based on the timing data, and to sequentially transmit the packets stored in the packet buffer section to the packet transmitting section each time the current time notified from the real time clock reaches the transmission time of each of the packets

### BRIEF DESCRIPTION OF THE DRAWINGS

The above and other objects, advantages and features of the present invention will be more apparent from the following description of exemplary embodiments made in conjunction with the attached drawings, in which:

FIG. 1 is a diagram showing an entire configuration of a packet distribution system according to a first exemplary embodiment of the present invention;

FIG. 2 is a block diagram showing configurations of a packet transfer apparatus and a reproducing apparatus in the packet distribution system in first exemplary embodiment of the present invention;

FIG. 3 is a flowchart showing a packet selecting operation of the packet transfer apparatus according to the first exemplary embodiment of the present invention;

FIG. 4 is a diagram showing a configuration of an IP header of an IP packet;

FIG. 5 is a diagram showing a configuration of an UDP header of a UDP packet;

FIG. 6 is a flowchart showing an operation of the packet transfer apparatus in the first exemplary embodiment of the present invention to acquire a timing data;

FIG. 7 is a diagram showing a configuration of an RTP header of an RTP packet;

FIG. 8 is a diagram showing a timing data in the first exemplary embodiment of the present invention;

FIG. 9 is a diagram showing a division example when the RTP packet is converted into the IP packet;

FIG. 10 is a diagram showing the timing data in the first exemplary embodiment of the present invention;

FIG. 11 is a flowchart showing an operation of a packet buffer section in the reproducing apparatus in the first exemplary embodiment of the present invention;

FIG. 12 is a flowchart showing an operation of the packet buffer section in the reproducing apparatus in the first exemplary embodiment of the present invention;

FIG. 13 is a flowchart showing an operation of a transmission scheduler in the reproducing apparatus in the first exemplary embodiment of the present invention;

FIG. 14 is a block diagram showing a configuration of a packet transfer apparatus with a reproducing apparatus in a second exemplary embodiment of the present invention;

FIG. 15 is a flowchart showing a transmission time difference determining operation in the reproducing apparatus in the second exemplary embodiment of the present invention; and

FIG. 16 is a block diagram showing a configuration of the packet transfer apparatus and a reproducing apparatus in a third exemplary embodiment of the present invention.

### EXEMPLARY EMBODIMENTS

Hereinafter, a packet distribution system according to exemplary embodiments of the present invention will be described with reference to the attached drawings.

### First Exemplary Embodiment

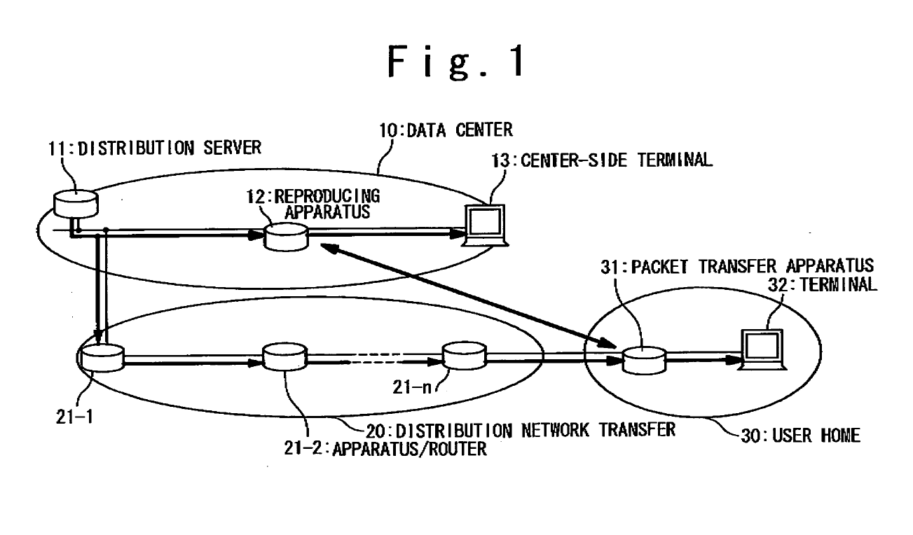

FIG. 1 is a diagram showing a packet transferring system according to a first exemplary embodiment of the present invention. Referring to FIG. 1, the packet transferring system according to the first exemplary embodiment has a data center 10, a distribution network 20 and a user home 30. The data center 10 contains a distribution server 11, a reproducing apparatus 12 and a center side terminal 13. The distribution network 20 contains routers 21 (21-1, 21-2, . . . , 21-n). The user home 30 contains a packet transfer apparatus 31 and a terminal 32.

The distribution server 11 transmits data packets through the reproducing apparatus 12 to the center side terminal 13. Also, the distribution server 11 transmits the data packet through the routers 21 and the packet transfer apparatus 31 to the terminal 32. It should be noted that the routers 21 (21−i, i=1 to n: n is the number of routers) is at least one relaying apparatus.

The reproducing apparatus 12 stores the packets transmitted from the distribution server 11. Also, the reproducing apparatus 12 receives a packet reception timing data sent from the packet transfer apparatus 31. Moreover, the reproducing apparatus 12 determines the transmission timing of each packet stored in a packet buffer in accordance with the timing data. At this time, the reproducing apparatus 12 and the center side terminal 13 communicate with each other through the routers 21. However, if the reproducing apparatus 12 and the packet transfer apparatus 31 can communicate with each other through a different communication route such as a public telephone network or a wireless communication network, they can communicate with each other without intervention of any router 21. The reproducing apparatus 12 receives from the packet transfer apparatus 31, timing data including a sequence number of a received packet and a reception time in the packet transfer apparatus 31, and transmits the same packet after a predetermined time ts from the reception time in the packet transfer apparatus. Thus, an image reproduction state on the terminal 32 can be reproduced on the center side terminal 13.

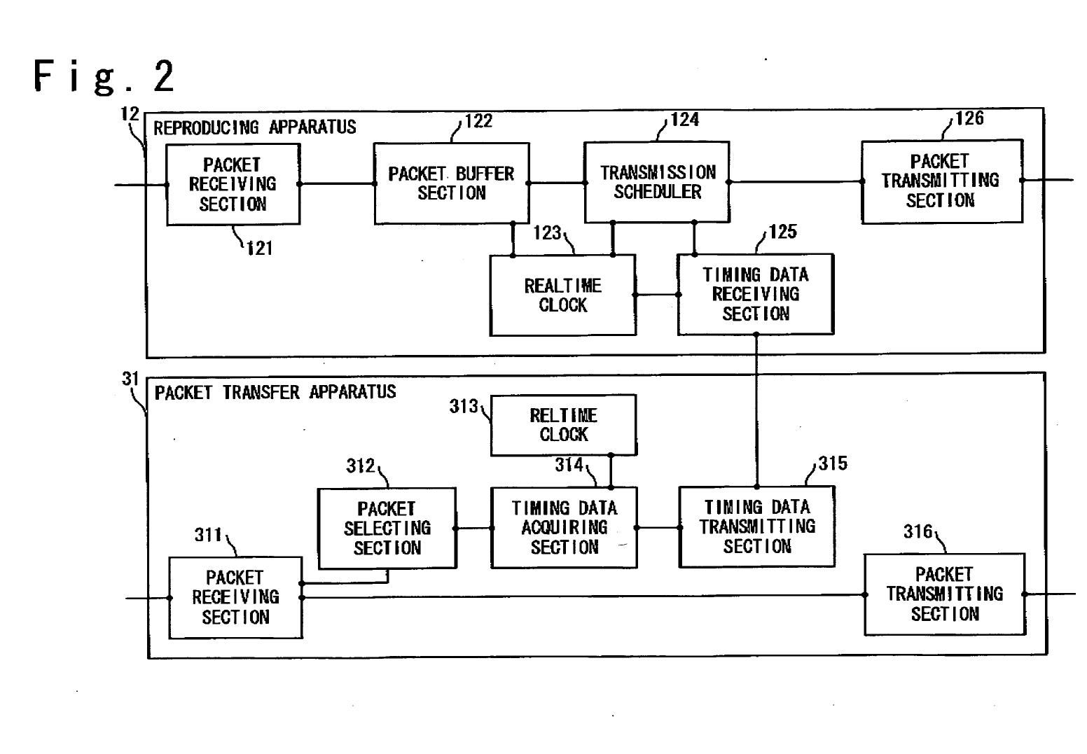

FIG. 2 is a block diagram showing the configurations of the reproducing apparatus and the packet transfer apparatus of the present invention. Referring to FIG. 2, the reproducing apparatus 12 contains a packet receiving section 121, a packet buffer section 122, a real time clock 123, a transmission scheduler 124, a timing data receiving section 125 and a packet transmitting section 126. Also, the packet transfer apparatus 31 contains a packet receiving section 311, a packet selecting section 312, a real time clock 313, a timing data acquiring section 314, a timing data transmitting section 315 and a packet transmitting section 316.

Each section in the reproducing apparatus 12 will be described below.

The packet receiving section 121 receives the packets sent from the distribution server 11 and sends to the packet buffer section 122. The packet buffer section 122 stores the packets received by the packet receiving section 121. The real time clock 123 notifies a held current time to each section. The transmission scheduler 124 determines a transmission time of each packet stored in the packet buffer section 122 in accordance with the timing data received from the timing data receiving section 125 and checks the current time from the real time clock 123. When it arrives at the transmission time, the packet is sent to the packet transmitting section 126. The timing data receiving section 125 receives the timing data sent by the packet transfer apparatus 31 and sends to the transmission scheduler 124. The packet transmitting section 126 transmits the packets sent from the transmission scheduler 124 to the center side terminal.

Each section in the packet transfer apparatus 31 will be described below. The packet receiving section 311 receives all of the packets sent through a network and sends to the packet selecting section 312 and the packet transmitting section 316. The packet selecting section 312 selects only the packet of a monitor target from the packets and sends to the timing data acquiring section 314. The real time clock 313 notifies the held current time to each section. The timing data acquiring section 314 determines the reception time of each packet sent from the packet selecting section 312, based on the time reported by the real time clock 313. Also, the timing data acquiring section 314 generates the timing data as a set from a sequence number of the packet and the reception time and then sends to the timing data transmitting section 315. The timing data transmitting section 315 sends the timing data received from the timing data acquiring section 314 to the reproducing apparatus 12. The packet transmitting section 316 transmits the packets sent from the packet receiving section 311.

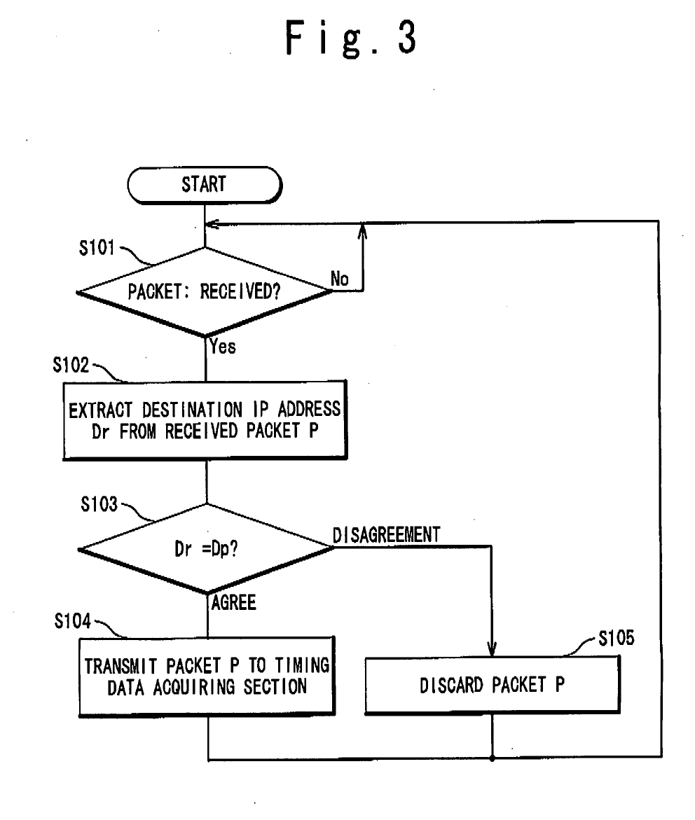

The operation of the packet selecting section will be described below with reference to FIG. 3.

### (1) Step S101

The packet selecting section 312 waits for the packets transmitted from the packet receiving section 311.

### (2) Step S102

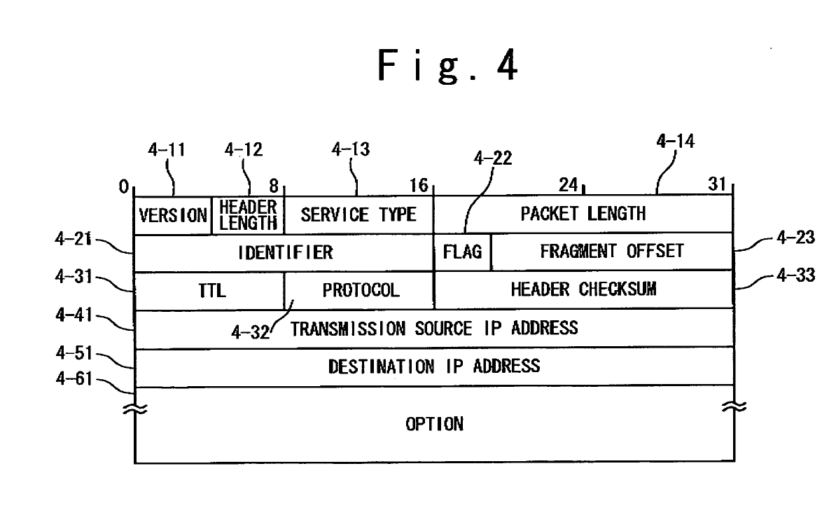

A destination IP address Dr is extracted from a received packet P. The IP header in the packet P is as shown in FIG. 4. A reference numeral 4-51 denotes a filed for the destination IP address in FIG. 4.

### (3) Step S103

Next, the destination IP address Dr of the packet P is compared with a monitor target destination IP address Dp.

### (4) Step S104

At this time, the packet having the address Dr which is coincident with the address Dp is sent to the timing data acquiring section 314.

### (5) Step S105

The packets which are sent to the packet selecting section 312 and are not coincident with the address Dp are discarded.

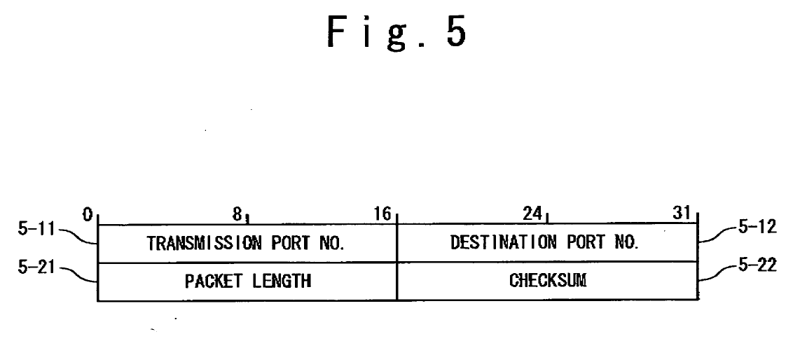

At the step S103, only the destination IP address is compared. However, as the monitor target, a source IP address 4-41 in the IP header FIG. 4, a source port number 5-11 of a UDP header in FIG. 5, and a destination port number 5-12 may be combined and used. In this case, the step S103 is as follows. Only when all of the destination IP address 4-51 and the transmission source IP address 4-41 in the IP header shown in FIG. 4 and the transmission source port number 5-11 and the destination port number 5-12 in the UDP header shown in FIG. 5 are coincident with the values of the respective fields registered in advance as the monitor target, the operation flow proceeds to the step S104. Otherwise, the operation flow proceeds to the step S105.

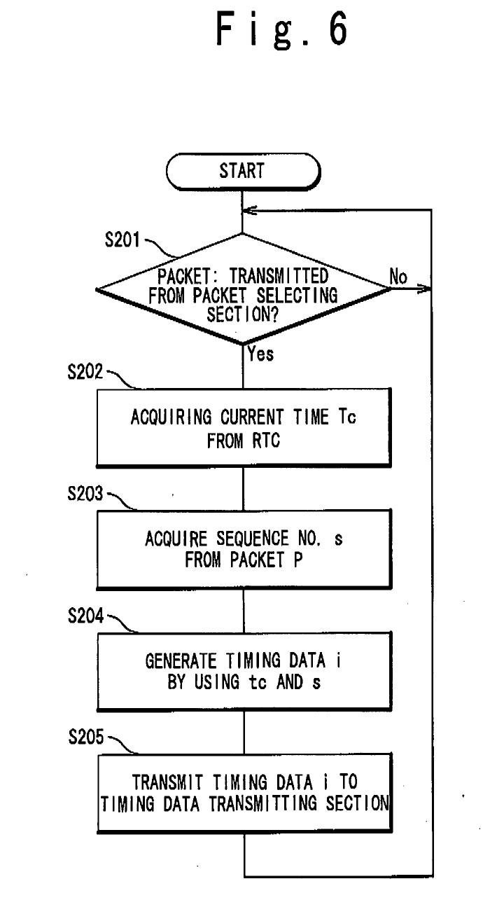

The operation of the timing data acquiring section will be described below with reference to FIG. 6.

### (1) Step S201

The timing data acquiring section 314 in FIG. 2 waits for the transmission of the packet from the packet selecting section 312.

### (2) Step S202

When the packet is sent from the packet selecting section 312, the timing data acquiring section 314 acquires the current time tc from the real time clock 123 in FIG. 2.

### (3) Step S203

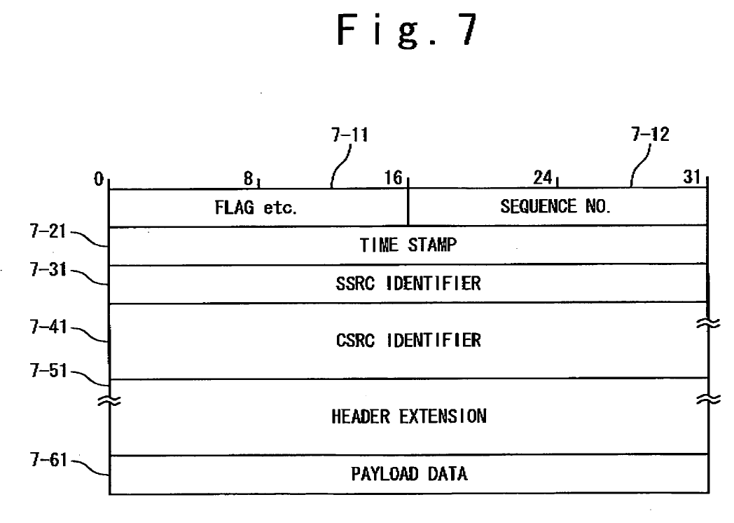

Next, the timing data acquiring section 314 refers to the packet sent from the packet selecting section 312 and extracts the sequence number. Here, the sequence number is a value stored in the field 7-12 in an RTP (Realtime Transport Protocol) header, as shown in FIG. 7.

### (4) Step S204

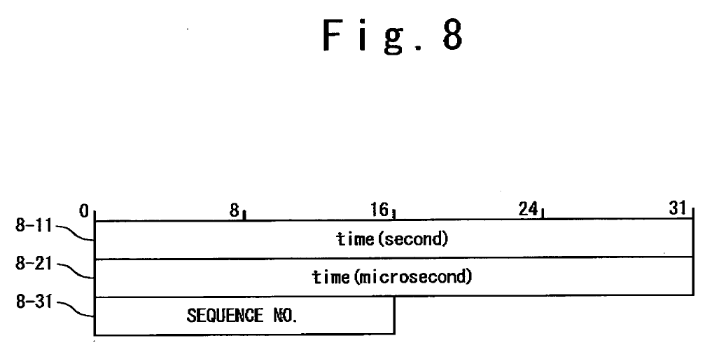

Next, the timing data i is generated from the current time tc acquired at the step 202 and a sequence number s acquired at the step 203. As shown in FIG. 8, the timing data is composed of fields 8-11 and 8-21 in which the times are written with respect to 1970/1/10:00 as epoch; and a field 8-31 in which the sequence number (16 bits) is written. Here, the lengths of fields in which the current times are written are 32 bits, respectively. However, they may be the different field lengths as necessary.

### (5) Step S205

The generated timing data i is sent to the timing data transmitting section 315 in FIG. 2.

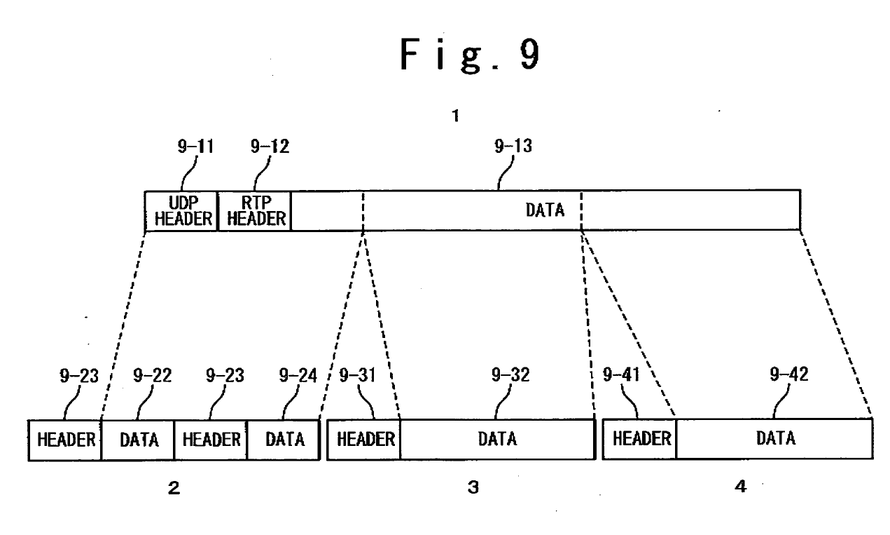

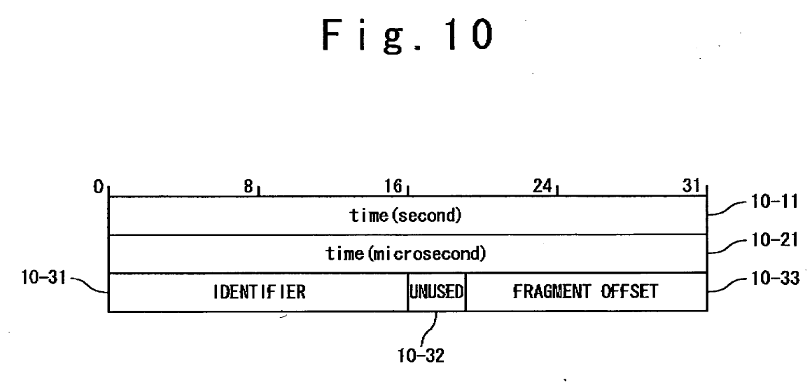

The step S204 may be as follows. That is, the set of the values of an identifier 4-21 and a fragment offset 4-23 in the IP header shown in FIG. 4 may be used instead of the RTP sequence numbers in the foregoing example. In the foregoing method, the process is carried out in units of RTP packets since the RTP header is used. When the size of the RTP packet is large, the RTP packet is divided at the stage for assigning the IP header and transmitted, as shown in FIG. 9. The elements to be used when the divided data are again assembled in a reception destination are the identifier field 4-21 and fragment offset field 4-23 in the IP header in FIG. 4. In FIG. 9, divided packet groups 2, 3 and 4 have a same identifier. Also, in the fragment offset field, the packet group 2 shown as a head fragment in FIG. 9 stores 0, and the other packet groups 3 and 4 store their relative positions as values in units of 8 octets. By using the set of those values, it is possible to uniquely specify the packet in an IP level. When those values are used, the timing data is not generated not in units of the RTP packets but in units of the IP packets. FIG. 10 shows the timing data at this time.

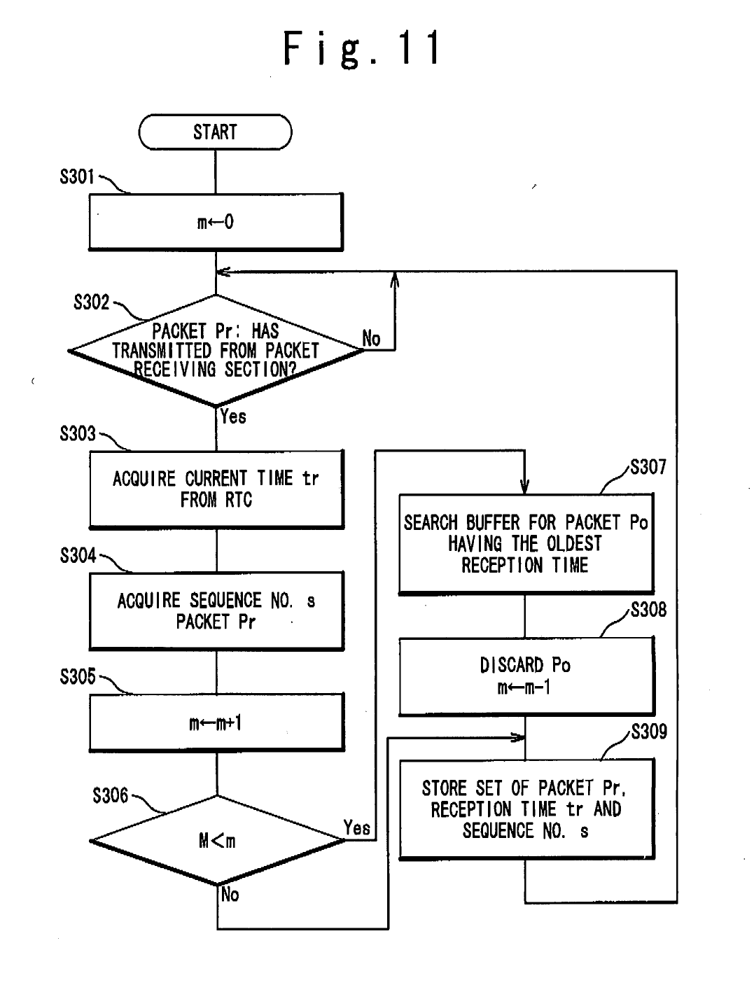

The operation of the packet buffer section will be described below with reference to FIG. 11.

### (1) Step S301

The value 0 is set to a packet number counter m.

### (2) Step S302

Next, the packet buffer section 122 waits for transmission of the packets received by the packet receiving section 121.

### (3) Step S303

When the packets are received, the packet buffer section 122 acquires the current time from the real time clock 123 in FIG. 2, and defines as a reception time tr.

### (4) Step S304

Next, the packet buffer section 122 acquires the sequence number s of the RTP from a packet Pr. Therefore, as described in the timing data acquiring section 314, the set of the identifier and fragment offset in the IP header may be used instead of the RTP sequence number.

### (5) Step S305

The value 1 is added to the packet number counter.

### (6) Step S306

The number m of packets and a maximum number M of packets in the buffer are compared. If the number m of packets is equal to or less than the maximum number M of packets in the buffer, the operation flow proceeds to a step S309.

### (7) Step S307

If the number m of packets is greater than the maximum number M of packets in the buffer, the oldest packet Po with regard to the reception time is searched from the packet buffer.

### (8) Step S308

The searched packet Po is discarded so as to decrease the number m of packets by one.

### (9) Step S309

The packet Pr, the reception time tr and the sequence number s are used as a set and registered in an empty region of the buffer.

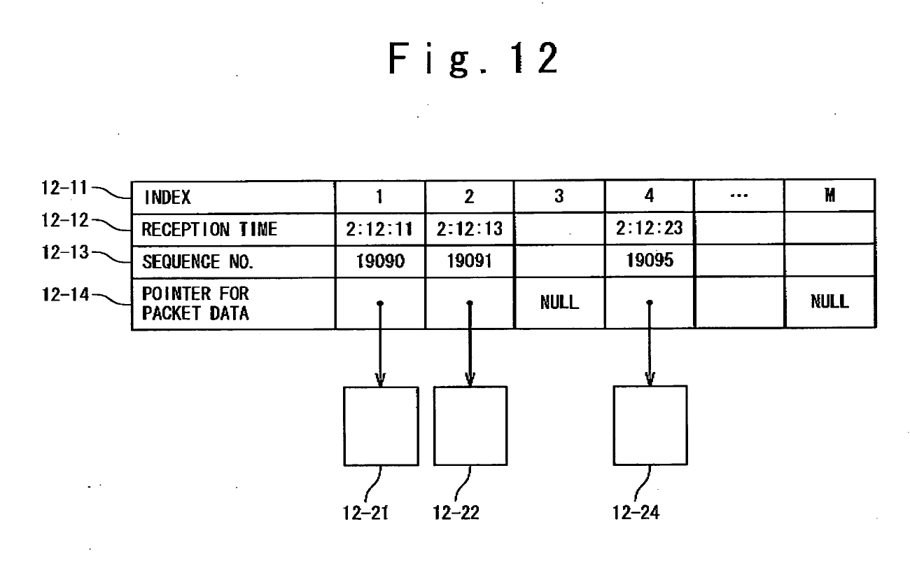

FIG. 12 shows the structure of the packet buffer section. The packet buffer is an array of a size M in which an index 12-11, a reception time 12-12, a sequence number 12-13 and a pointer 12-14 to a packet data are defined as one set. When the packet is stored, regions 12-21 to 12-24 for storing the packet are reserved, and the pointers to the regions are stored in the pointer 12-14 to the packet data. When the point to the packet data is NULL, this implies that the buffer of that index number is not used.

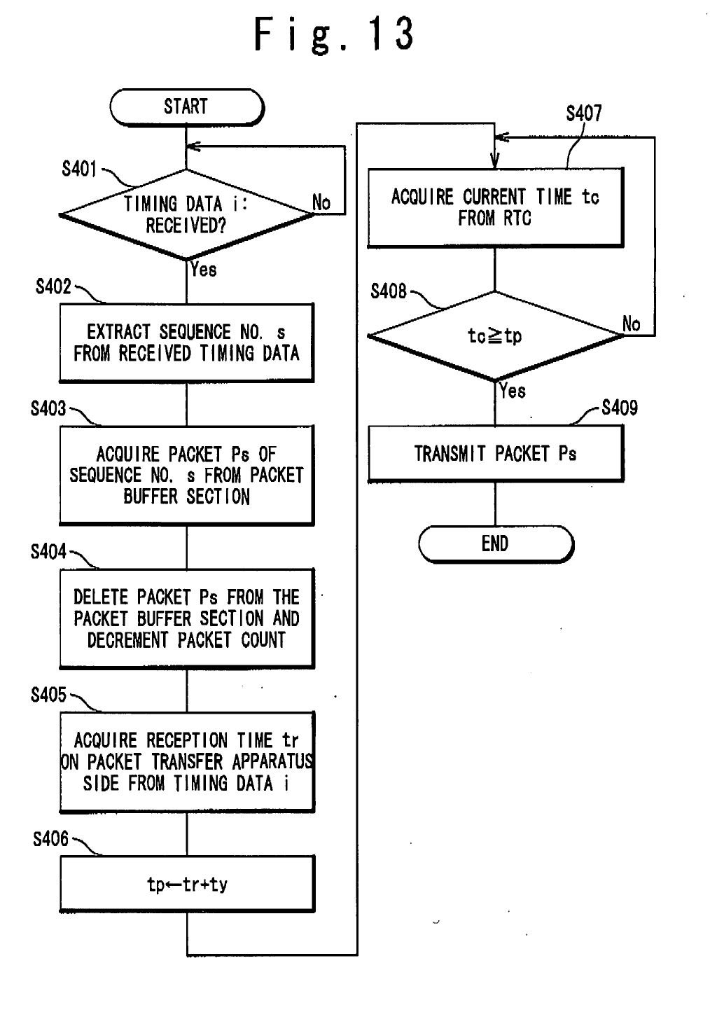

The operation of the transmission scheduler will be described below with reference to FIG. 13.

### (1) Step S401

The timing data receiving section 125 waits for reception of the timing data.

### (2) Step S402

When the timing data i is sent from the timing data receiving section 125, the sequence number s is extracted from it.

### (3) Step S403

Next, a packet Ps of the sequence number s is taken out from the packet buffer section 122.

### (4) Step S404

The packet Ps is removed from the packet buffer section 122, and 1 is subtracted from the packet number counter in the packet buffer section 122.

### (5) Step S405

Next, the transmission scheduler 124 acquires a packet transfer apparatus side reception time tr from the timing data i.

### (6) Step S406

Next, a margin time ty is added to the packet transfer apparatus side reception time tr, to determine a transmission time tp. Here, the margin time ty is a value determined in advance from a configuration.

### (7) Step S407

Next, the transmission scheduler 124 acquires the current time tc by referring to the real time clock.

### (8) Step S408

The transmission scheduler 124 compares the current time tc and the transmission time tp, and if the former is smaller, namely, if it does not still arrive at the transmission time, the operation flow returns to the step S407.

### (9) Step S409

If the value of the current time to is equal to or greater than the value of the transmission time tp, the packet Ps is sent out from the packet transmitting section 126.

### Second Exemplary Embodiment

A distribution system according to a second exemplary embodiment of the present invention will be described below in detail with reference to the drawings.

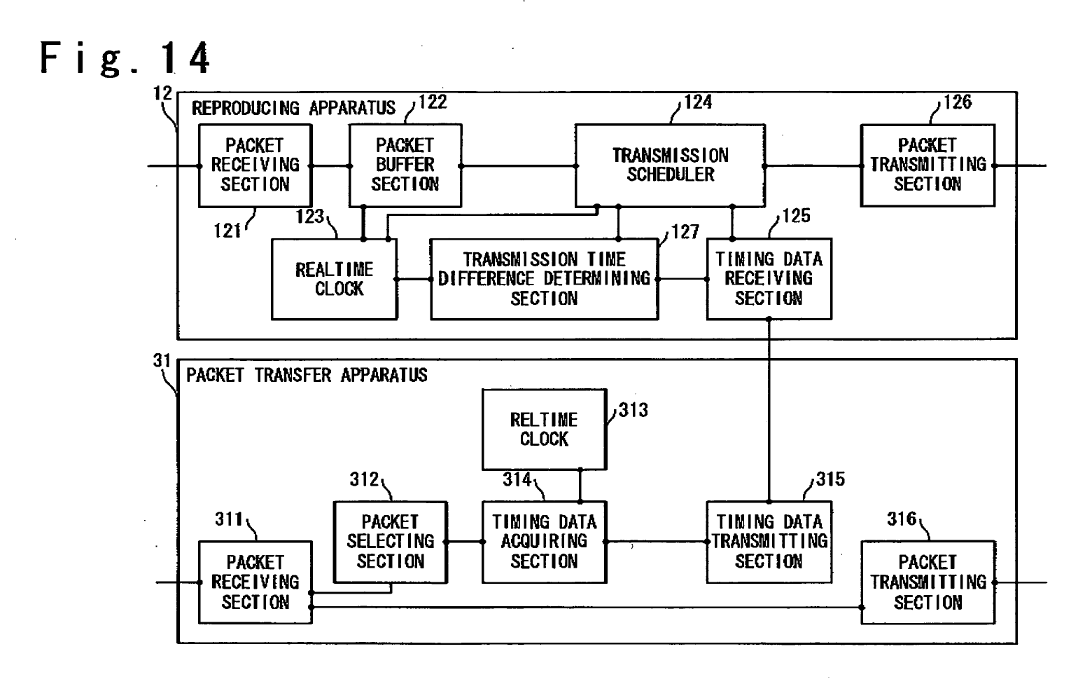

With reference to FIG. 14, the reproducing apparatus 12 contains the packet receiving section 121, the packet buffer section 122, the real time clock 123, the transmission scheduler 124, the timing data receiving section 125, the packet transmitting section 126 and a transmission time difference determining section 127. Also, the packet transfer apparatus 31 contains the packet receiving section 311, the packet selecting section 312, the real time clock 313, the timing data acquiring section 314, the timing data transmitting section 315 and the packet transmitting section 316. The second exemplary embodiment differs from the first exemplary embodiment of the present invention in that the reproducing apparatus 12 has the transmission time difference determining section 127. The transmission time difference determining section 127 determines the transmission time difference, which implies a difference between the packet reception time in the packet transfer apparatus 31 and the transmission time of the packet in the reproducing apparatus 12. At this time, the transmission time difference determining section 127 is connected to the real time clock 123, the transmission scheduler 124 and the timing data receiving section 125.

The transmission time difference will be described. At first, it is supposed that the times in the packet transfer apparatus 31 and the reproducing apparatus 12 are perfectly coincident. For example, it is supposed that the packet transfer apparatus 31 receives a packet of the sequence number of 123456 at the reception time of 0:12:10. In the reproducing apparatus 12, it is supposed that the reception time of the timing data sent from the packet transfer apparatus 31 was 0:12:13. At this time, the difference of 3 seconds between the packet reception time of 0:12:10 in the packet transfer apparatus 31 and the reception time of 0:12:13 of the timing data in the reproducing apparatus 12 is referred to as a reception time difference. The transmission time difference is measured a predetermined number of times N, and its average value is calculated. The value obtained by adding the margin time to this average reception time difference is defined as the transmission time difference. Here, when the margin time is assumed to be 3 seconds, the transmission time difference is 6 seconds. In short, the packet arriving at the packet transfer apparatus 31 at 0:12:10 is sent out from the reproducing apparatus 12 at 0:12:16. On the other hand, the packet arriving at the packet transfer apparatus 31 is transmitted to the center side terminal in its original state without any interval. Thus, the center side terminal can reproduce the video image at the delay of 6 seconds from the user home terminal.

Here, although the times in the packet transfer apparatus 31 and the reproducing apparatus 12 are assumed to be perfectly coincident, there is no problem even if they are not actually coincident. For example, it is supposed that the time of the side of the reproducing apparatus 12 is delayed by 5 seconds from the time of the side of the packet transfer apparatus 31. In this case, the timing data actually arrives at the reproducing apparatus 12 at 0:12:13 in case of the time of the side of the packet transfer apparatus 31. However, the time of the reproducing apparatus 12 is delayed by 5 seconds. Thus, the arrival of the timing data at 0:12:08 is measured. Moreover, the packet reception time in the arriving timing data becomes 0:12:10. Thus, the reception time difference becomes −2 seconds. In this way, it is allowable that the reception time difference has such a minus value. Therefore, the time difference between the reproducing apparatus 12 and the packet transfer apparatus 31 can be allowed.

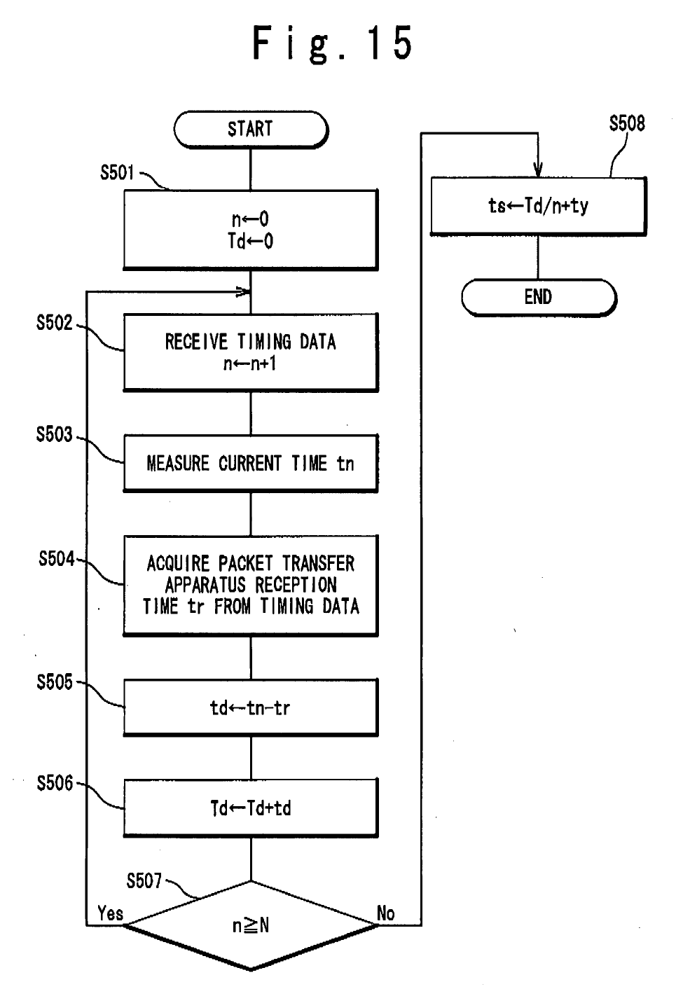

A procedure for the transmission time difference determining section to determine a transmission time difference ts when the reproducing apparatus 12 starts reproducing the video image will be described with reference to FIG. 15.

### (1) Step S501

At first, variables n and Td are set to 0.

### (2) Step S502

Next, the transmission time difference determining section 127 waits for the reception of the timing data from the timing data receiving section 125. When the timing data is received, 1 is added to the variable n.

### (3) Step S503

Next, a current time tn is measured.

### (4) Step S504

Moreover, the reception time tr of the packet in the packet transfer apparatus 31 is acquired from the received timing data.

### (5) Step S505

Next, the difference between the current time tn and the reception time tr in the packet transfer apparatus 31 is calculated, and a reception time difference tr is determined.

### (6) Step S506

The determined reception time difference td is added to the Td.

### (7) Step S507

Next, the value of the variable n and the value of a measurement timing data upper limit N is compared. Here, the value of the measurement timing data upper limit N is assumed to be a value defined in advance based on the configuration. At the step S507, if the value n is smaller than the value N, the operation flow returns to the step S502.

### (8) Step S508

If the value n is equal to or greater than the value N, a transmission time difference ts is calculated by adding the margin time ty to a value obtained by dividing Td by n. Here, the margin time ty is a value defined in advance based on the configuration.

In this exemplary embodiment, although the process for determining the transmission time difference uses an average of the reception time differences, the maximum value of the reception time differences may be used. Also, in the foregoing case, a method is employed in which the number of the timing data is defined in advance when calculating the average reception time difference. However, a method may be adopted in which the measurement time is defined in advance and the timing data arriving at the reproducing apparatus 12 within the time is used to calculate the transmission time difference.

Also, in this exemplary embodiment, the value of the margin time ty is determined from the configuration. However, the following method may be employed. That is, this exemplary embodiment uses an average value of the transmission time differences. However, when the transfer time of the timing data greatly exceeds this average value, there is a possibility that the timing data of the packet does not arrive until the packet transmission time in the reproducing apparatus 12. In order to preventing from this possibility, the value of the margin time ty may be great. However, if this value is too great, the time difference becomes great between the video image reproduced by the terminal 32 in the user home 30 and the video image reproduced by the center side terminal 13. In order to determine a proper transmission time difference ts, the following procedure is performed. A variance is determined in accordance with the average value when the reception time difference is measured. The calculated average value and variance and a probability distribution function for a normal distribution are used to determine the time when 99% of the timing data arrives, and that value is defined as the transmission time difference. Here, although the probability distribution function for the normal distribution is used, the probability distribution function of a different distribution may be used in accordance with the property of the network.

In this exemplary embodiment, only when the reproducing apparatus 12 starts reproducing the video image, the transmission time difference is determined. However, in order to follow the state change in the network, a process for calculating the transmission time difference may be performed for every predetermined time, and the transmission time difference may be updated each time.

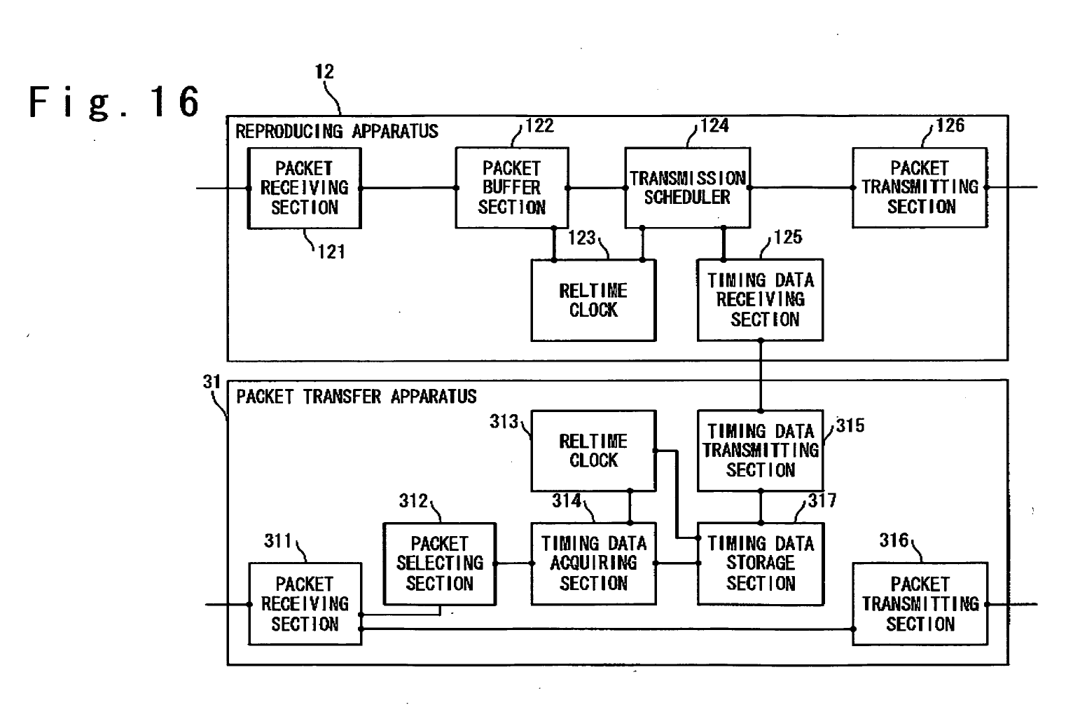

The distribution system according to a third exemplary embodiment of the present invention will be described below in detail with reference to the drawings. With reference to FIG. 16, the reproducing apparatus 12 contains the packet receiving section 121, the packet buffer section 122, the real time clock 123, the transmission scheduler 124, the timing data receiving section 125 and the packet transmitting section 126. Also, the packet transfer apparatus 31 contains the packet receiving section 311, the packet selecting section 312, the real time clock 313, the timing data acquiring section 314, the timing data transmitting section 315, the packet transmitting section 316 and a timing data storage section 317. The first exemplary embodiment is differs from the first exemplary embodiment of the present invention in that the packet transfer apparatus 31 has the timing data storage section 317.

The timing data storage section 317 stores the timing data received from the timing data acquiring section 314. The stored timing data is sent to the timing data transmitting section 315 collectively for each predetermined constant time. The timing data transmitting section 315 sends the timing data collected within a predetermined time to the reproducing apparatus 12 as a collective timing data. Consequently, the number of the times when the timing data are sent is reduced, which can decrease the load for the timing data transmission.

In this exemplary embodiment, the packet transfer apparatus 31 transmits the timing data to the reproducing apparatus 12 for every predetermined time. However, the transmission of the timing data may be performed as follows. The transmission process load is applied to the transmission of the timing data. Thus, there is a possibility that the transmission of the timing data influences on the packet receiving process in the packet receiving section 311 and the packet transmitting process in the packet transmitting section 316 in FIG. 16. For this reason, the following method may be employed. That is, the timing data transmitting section 315 checks whether or not the respective processes of the packet receiving section 311 and the packet transmitting section 316 are being performed, at the transmission timing of the timing data for every predetermined time. If they are not being performed, the process for transmitting the timing data is performed. If they are being performed, the process for transmitting the timing data is performed after the completions of the respective processes. Such as, the timing data can be transmitted without any influence on the process for transmitting the packet.

It should be noted that the reproducing apparatus and packet transfer apparatus of the present invention can be used to monitor the reproduction of the video image in the image distribution service. Also, when the user for providing the service has the problem in the video image reproduction, the present invention can be used to search its cause.

In FIG. 1, the packet arrival state in a terminal 32 at a user home 3 and the arrival interval thereof can be reproduced in a terminal 13 placed on the side of a center side 1. The loss of the packets directly leads to the intermission of the image or voice. However, through the reproduction of the arrival state, the center side terminal can check the manner of an influence in the video image reproduction. Also, when the delay of the packet becomes great, since even at the reproduction time of a predetermined image frame, the arrival of the packets of the frame are delayed, which results in a possibility of the occurrence of the situation that the reproduction is impossible. Even such phenomenon can be reproduced in the center side terminal 13.

Although the inventions has been described above in connection with several exemplary embodiments thereof, it will be apparent by those skilled in the art that those exemplary embodiments are provided solely for illustrating the present invention, and should not be relied upon to construe the appended claims in a limiting sense.

What is claimed is:

1. A packet distribution system comprising:
a distribution server configured to transmit packets of a video image;
a user terminal;
a packet transfer apparatus configured to transfer the packets received through a network from said distribution server to said user terminal such that the video image is reproduced on said user terminal, and to generate timing data from the received packets;
a center terminal; and
a reproducing apparatus configured to receive said timing data from said packet transfer apparatus, to receive the packets from said distribution server, and to transmit the received packets to said center terminal based on said timing data such that the video image is reproduced on said center terminal.

2. The packet distribution system according to claim 1, wherein said packet transfer apparatus comprises:
a packet receiving section configured to receive the packets through the network from said distribution server;
a packet transmitting section configured to transmit the packets to said user terminal;
a real time clock configured to supply a current time;
a packet selecting section configured to select monitor target packets from among the packets received by said packet receiving section;
a timing data acquiring section configured to determine a reception time of each of said monitor target packets from the current time supplied from said real time clock, and to produce said timing data as a set of the reception time of said monitor target packet and an identifier of said monitor target packet and
a timing data transmitting section configured to transmit said timing data to said reproducing apparatus.

3. The packet transfer system according to claim 2, wherein said timing data acquiring section produces said timing data by using a sequence number of an RTP header as the identifier.

4. The packet transfer system according to claim 2, wherein said timing data acquiring section produces said timing data by using a set of a fragment offset and an identifier of an IP header as the identifier.

5. The packet transfer system according to claim 2, wherein said timing data transmitting section comprises:
a timing data storage section configured to store said timing data generated for every predetermined time by said timing data acquiring section,
said timing data transmitting section is configured to transmit said timing data stored within said predetermined time in said timing data storage section to a reproducing apparatus.

6. The packet transfer system according to claim 1, wherein said reproducing apparatus comprises;
a packet receiving section configured to receive the packets from said distribution server;
a packet transmitting section configured to transmit the packets to said center terminal;
a real time clock configured to supply a current time;
a packet buffer section configured to store the packets received by said packet receiving section;
a timing data receiving section configured to receive said timing data of a set of an identifier for each of the packets and a reception time of the packet from a packet transfer apparatus; and
a transmission scheduler configured to determine a transmission time of each of the packets based on said timing data, and to control said packet transmitting section to sequentially transmit the packets stored in said packet buffer section to said center terminal each time the current time notified from said real time clock reaches the transmission time of each of the packets.

7. The packet transfer system according to claim 6, wherein said transmission scheduler is configured to determine the transmission time of the packets based on said timing data such that a transmission interval is identical to a packet reception interval in said packet transfer apparatus.

8. The reproducing apparatus according to claim 6, further comprising:
a transmission time difference determining section configured to measure a reception time of said timing data, and to determine a difference between said packet transmission time and said packet reception time in said packet transfer apparatus.

9. A method of distributing packets for a video image, comprising:
transmitting packets for a video image from a distribution server;
receiving the packets through a network from said distribution server by a packet transfer apparatus to transfer to a user terminal such that the video image is reproduced on said user terminal;
generating timing data from the packets received through the network by said packet transfer apparatus;
receiving the packets from said distribution server by a reproducing apparatus; and
transmitting the received packets to a center terminal based on said timing data by said reproducing apparatus such that the video image is reproduced on said center terminal.

10. The method according to claim 9, wherein said receiving the packets through a network by a packet transfer apparatus comprises:
receiving the packets through the network from said distribution server; and
transmitting the packets received through said network, to said user terminal, and said generating timing data from the packets received through the network by said packet transfer apparatus, comprises:
supplying a current time;
selecting said monitor target packets from among the packets received by said packet receiving section;
determining a reception time of each of said monitor target s from the current time supplied from said real time clock;
producing said timing data as a set of the reception time of said monitor target packet and an identifier of said monitor target packet; and
transmitting said timing data to said reproducing apparatus.

11. The method according to claim 10, wherein said timing data comprises a sequence number of an RTP header as the identifier.

12. The method according to claim 10, wherein said timing data comprises a set of a fragment offset and an identifier of an IP header as the identifier.

13. The method according to claim 10, wherein said transmitting said timing data section comprises:
storing said timing data generated for every predetermined time; and
transmitting said timing data stored within said predetermined time.

14. The method according to claim 9, wherein said transmitting the received packets to a center terminal comprises:
supplying a current time;
storing the packets received from said distribution server;
receiving said timing data of a set of an identifier for each of the packets and a reception time of the packet from said packet transfer apparatus; and
determining a transmission time of each of the packets based on said timing data; and
sequentially transmitting the stored packets to said center terminal each time the current time reaches the transmission time of each of the packets.

15. The method according to claim 14, wherein said transmission scheduler is configured to determine the transmission time of the packets based on said timing data such that a transmission interval is identical to a packet reception interval in said packet transfer apparatus.

16. The method according to claim 14, further comprising:
measuring a reception time of said timing data; and
determining a difference between said packet transmission time and said reception time of the packet in said packet transfer apparatus.

17. A reproducing apparatus comprising:
a packet receiving section configured to receive packets from a distribution server;
a packet transmitting section configured to transmit the packets to a center terminal;
a real time clock configured to supply a current time;
a packet buffer section configured to store the packets received by said packet receiving section;
a timing data receiving section configured to receive a timing data of a set of an identifier for each of the packets and a reception time of the packet from a packet transfer apparatus; and
a transmission scheduler configured to determine a transmission time of each of the packets based on said timing data, and to control said packet transmitting section to sequentially transmit the packets stored in said packet buffer section to said center terminal each time the current time notified from said real time clock reaches the transmission time of each of the packets.

18. The reproducing apparatus according to claim 17, wherein the identifier is a sequence number of an RTP header of the packet.

19. The reproducing apparatus according to claim 17, wherein the identifier is a set of an identifier of an IP header and a fragment offset.

20. The reproducing apparatus according to claim 17, wherein said transmission scheduler is configured to determine the transmission time of the packets based on said timing data such that a transmission interval is identical to a packet reception interval in said packet transfer apparatus.

21. The reproducing apparatus according to claim 17, further comprising:
a transmission time difference determining section configured to measure a reception time of said timing data, and to determine a difference between said packet transmission time and said packet reception time in said packet transfer apparatus.
